(19) United States
(12) Patent Application Publication
(10) Pub. No.: US 2008/0011167 A1
(43) Pub. Date: Jan. 17, 2008

(54) DEVICE FOR FINISHING BUILDING BOARDS

(75) Inventors: Martin PRAGER, Heiligengrabe (DE); Frank OLDORFF, Schwerin (DE)

Correspondence Address: GREENBLUM & BERNSTEIN, P.L.C., 1950 ROLAND CLARKE PLACE, RESTON, VA, 20191, US

(73) Assignee: FLOORING TECHNOLOGIES LTD., Pieta (MT)

(21) Appl. No.: 11/675,915

(22) Filed: Feb. 16, 2007

(30) Foreign Application Priority Data
Feb. 24, 2006 (DE) 10 2006 008 626.0

(51) Int. Cl. B30B 7/04

(52) U.S. Cl. 100/232; 100/295; 29/557

(57) ABSTRACT

A device for finishing the surface of a building board of a pressed wood material, in particular MDF or HDF, or a wood material/plastic mixture, by embossing a structure or printing a pattern, with a pressing plate engraved according to the structure or the pattern and a tool carrier supported in a press device. The tool carrier is embodied as a hollow body and the pressing plate is releasably attached to the tool carrier directly and over the entire surface.

### CROSS REFERENCE TO RELATED APPLICATIONS

The present application claims priority under 35 U.S.C. 119 of German Patent Application No. 10 2006 008 626.0, filed on Feb. 24, 2006, the disclosure of which is expressly incorporated by reference herein in its entirety.

### BACKGROUND OF THE INVENTION

1. Field of the Invention

The invention relates to a device for finishing the surface of a building board of a pressed wood material, in particular MDF or HDF, or a wood material/plastic mixture, by embossing a structure or printing a pattern, with a pressing plate engraved with the structure or according to the pattern and a tool carrier supported in a press device.

A device of this type is known from DE 26 12 322 A1 as a press for pressing wood fiber products from a scattered cake. A chamber that can be evacuated is formed between the pressing plate and the tool carrier by a full-perimeter sealing plate, which chamber is filled with a metal-fabric net.

Flooring panels are known that are coated with synthetic resin on at least one large-area side and have a pattern and a so-called pattern-synchronous structure adapted to the pattern.

The pattern is present either as a paper layer laminated to a support board or as a paint coat printed directly onto the support board. Moreover, the pattern is coated in an abrasion-resistant manner. To this end either abrasion-resistant paper layers, so-called overlays, are used or varnish coats abrasion-resistant after curing. Wooden boards, such as, e.g., HDF or MDF boards, are often used as support boards.

The pattern-synchronous structure is present as a three-dimensional surface structure in the coating. The pattern-synchronous structure is embossed by a correspondingly three-dimensionally structured pressing plate. The constituents of the coating that can be activated thermally and under pressure thereby melt and fill up the three-dimensional structure and cure. The structures have a height of 0 to 500 μm, preferably 200 μm.

The decoration, on the one hand, and the application of a pattern-synchronous structure, on the other hand, take place in separate production stages. This leads to considerable disadvantages in the production of decorated flooring panels provided with pattern-synchronous structures.

DE 33 25 574 describes a mounting device for structure plates on an upper and/or lower pressing plate of a plate press for producing wooden boards, in which a full-perimeter soft seal is arranged in the area of the edge of the structure plate and the structure plate is attached by a vacuum. The structure plate is arranged on an upper support plate that is elastically deformable, and the support plate is attached to the upper pressing plate such that it can sag when the press is opened.

DE 44 14 309 discloses a method and a device for suspending the upper pressing plate on the upper heating plate of a heating press. The pressing plate is clamped on opposite sides by clamping fixtures and is attached such that it can sag.

Linking the decorating and structuring production steps of the floor panel to form one joint operation is not possible. Therefore a great effort is expended in terms of control in order to align a support plate provided with a pattern with the pressing plate bearing the structure synchronously with one another. A disadvantage particularly with the use of decorated papers is their undefined paper growth. Moreover, the size of the pressing plates is usually 6,000×2,000×5 mm so that pressing plates of this type are so heavy that they can be moved only with mechanical lifting gear. Due to the large weight, pressing plates of this type tend to sag when clamped in a press, which has a negative effect on the precision of the pattern-synchronous structure. Depending on the type of structure, 5,000 to 30,000 lifts can be achieved with such pressing plates. Each lift is thus prolonged in each case by alignment periods and leads to high costs.

### SUMMARY OF THE INVENTION

Based on this problem, the invention simplifies the clamping of structured pressing plates, which are used to finish the surface of finished pressed building boards, in a pressing device, to reduce the set-up times and to thereby render possible a uniform temperature and pressure distribution during the pressing operation.

To solve this problem a tool carrier is embodied as a wood body and the pressing plate is releasably attached to the tool body directly and over the entire surface.

Through the full-surface attachment of at least one structured pressing plate to the tool carrier, on the one hand, the installation and alignment of the structured pressing plate on the tool carrier can be carried out outside the press device, with a considerable reduction in effort, or the thin pressing plate can be easily released from the tool carrier without the press device having to be laboriously dismantled whenever a different structure is to be embossed or a different pattern is to be printed.

Advantageously the structured pressing plate is embodied to be very thin compared to the tool carrier. To this end, the thickness of the pressing plate is 0.2 to 2 mm, preferably 0.5 mm. The attachment of the thin pressing plates to at least one tool carrier mechanism results in considerably lower costs for the production of the pressing plates. Also, the handling of the pressing plates is simplified so that the set-up times can be reduced. Thin pressing plates of this type can also, e.g., be rolled and therefore are particularly easy to store and transport.

It has been shown that pressing plates of this type are suitable in particular for embossing a structure imitating a natural material, e.g., a wood pattern, into a building board that can be made of a wood material, in particular MDF, HDF or plastic. It is likewise possible to emboss the relief by a pressing plate of this type into building boards that are made of a mixture of wood material and plastic. Furthermore, it is possible to emboss a fantasy relief with pressing plates of this type.

To ensure that the thin pressing plate is attached to the tool carrier in an immovable manner, an adhesive attachment of the same to the tool carrier is possible.

It has been shown that it is likewise useful to attach the thin pressing plate to the tool carrier mechanically, pneumatically or magnetically, which renders possible a simple and easily reversible attachment to the tool carrier. Especially the mechanical, pneumatic or magnetic attachment to the tool carrier makes it easy to replace the plate, thus permitting shorter set-up times. In particular with mechanical, pneumatic or magnetic attachment to the tool carrier, the tool carrier can remain in the processing device during the attachment of the thin pressing plate.

Both a printing unit for decorative printing or a continuous or batch press device, e.g., a short-cycle press or a feed-through press can be used as a processing device.

In order to reduce the dwell time of the building board in the press, the tool carrier can be filled with a heat-transfer and/or pressure-transfer medium. Due to the thin pressing plate, heat and pressure can be transferred particularly well to the building board through this medium and the expenditure of force during pressing can be reduced. Temperatures of 150° C. to 250° C. and pressures of 200 to 800 N/cm², preferably 200 to 450 N/cm², are particularly suitable for the invention.

The heat-transfer and/or pressure-transfer medium can be inserted easily, since the tool carrier is embodied as a hollow metal body. The wall thickness of the tool carrier is approx. 1 mm, in particular on the side facing the pressing plate. This wall thickness is necessary for a sufficient rigidity of the tool carrier.

The tool carrier can be mounted in the processing device, e.g., by screwing. Thermal oil is particularly suitable as a heat-transfer and pressure-transfer medium. In order to conduct the thermal oil into the tool carrier and to place it under pressure, an adjustable pressure tap is provided on the tool carrier for the heat-transfer and pressure-transfer medium. On the one hand the thermal oil ensures the transfer of the necessary heat into the pressing plate for transfer to the plate to be processed and, on the other hand, it renders possible a leveling adjustment of pressing plate and the side of the tool carrier facing the pressing plate at uneven areas of the building board to be processed. In this manner surface irregularities of up to 0.1 mm in the building board can be leveled. Furthermore, an optimal heat transfer results with improved efficiency of the press and, on the other hand, an improved press result. Misses with areas not pressed out can be reliably avoided.

In addition, an upper or lower press pad can be arranged under the side of the tool carrier facing away from the pressing plate.

The method for engraving a structure into a pressing plate is characterized in that the structure is produced by a pulsed diamond tool, a laser or by die-sink eroding. Very precise engravings are possible, even in thin pressing plates, through these technologies. It is furthermore possible to apply the structure to the thin pressing plate by etching. In particular laser etching, inkjet etching, screen printing or roll etching technologies are hereby suitable, which likewise render possible a precise engraving of the thin pressing plates.

The building boards that are finished in the device according to the invention have a core of wood material, in particular HDF, MDF, a mixture of wood material and plastic or plastic. Onto this core (building board) an undercoat, the pattern and an abrasion-resistant layer are applied into which the pattern-synchronous structure then is embossed. Likewise, a counteracting layer, e.g., a counteracting layer of paper, can be arranged on the underside of the support board in order to counteract the bulging of the plate with a change in moisture (dishing). To ensure the finished building boards can be used, e.g., as flooring panels, grooves or tongues can be formed on the opposite side edges of the building board, which grooves or tongues can be provided in the horizontal and vertical direction with special locking elements to connect and lock the individual flooring panels.

### BRIEF DESCRIPTION OF THE DRAWINGS

An exemplary embodiment of the invention is explained in more detail below with the aid of a drawing. They show:

FIG. 1 shows a partial cross section through a short-cycle press with thin pressing plates and tool carriers;

FIG. 2 shows a partial cross section through a short-cycle press with thin pressing plates, tool carriers and press pads;

FIG. 3 shows a partial cross section through a building board finished in the device according to the invention; and

FIG. 4 shows a partial plan view of the building board finished in the device according to the invention.

### DETAILED DESCRIPTION OF THE PRESENT INVENTION

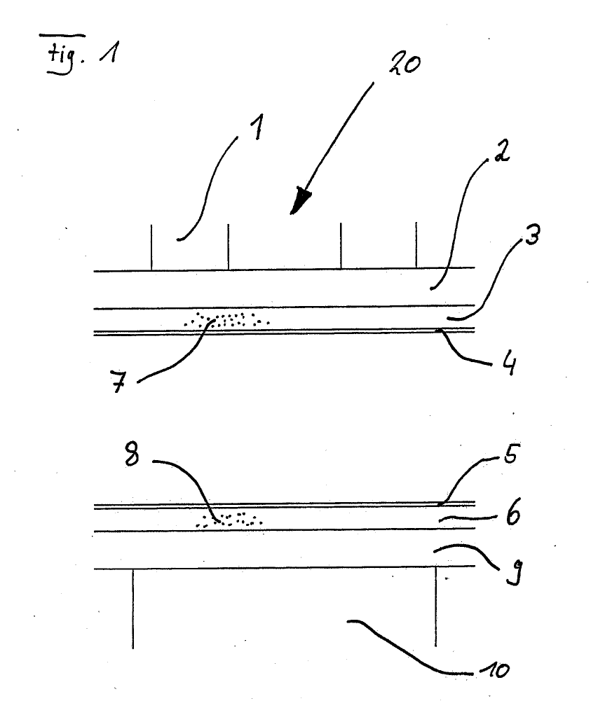

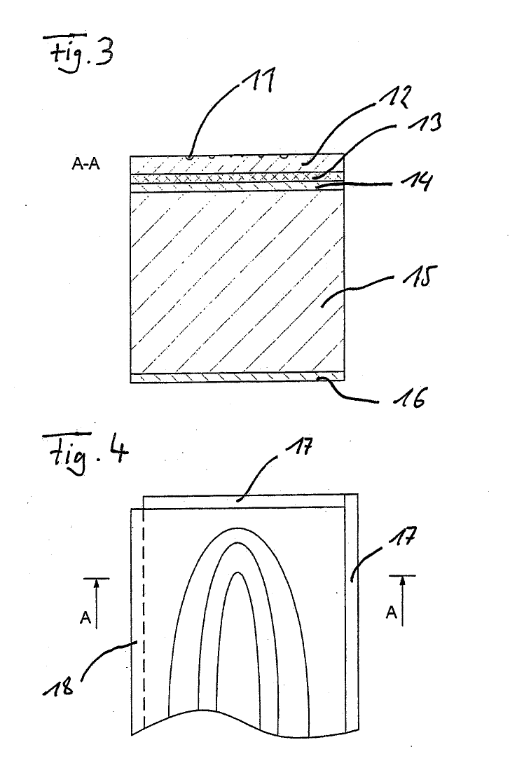

FIG. 1 shows a short-cycle press 20 that comprises two press cylinders 1, an upper frame 2, a lower frame 9 and a press bed 10. Respectively one tool carrier 3 or 6, which comprises a hollow metal body, is attached by screwing to the upper frame 2 or to the lower frame 9. An adjustable pressure tap (not shown) is provided on the tool carriers 3, 6 for the transfer of heat and pressure. Through this adjustable pressure tap the thermal oil 7, 8 reaches the upper tool carrier 3 or the lower tool carrier 6. Surface irregularities in the building board 15 (FIG. 3) can be compensated during embossing of the pattern-synchronous structure 11 (FIG. 3) by the filling of the tool carriers 3, 6 with thermal oil 7, 8. FIG. 1 also shows a pressing plates 4, 5 mounted on respective tool carriers 3, 6.

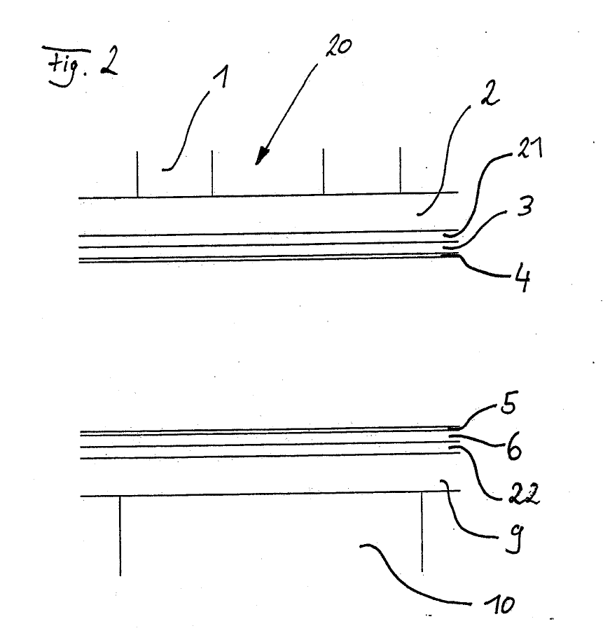

FIG. 2 shows the short-cycle press 20 from FIG. 1 in which, in contrast thereto, the tool carriers 3, 6 are not filled with a thermal oil 7, 8. In this exemplary embodiment it is necessary to arrange an upper press pad 21 and a lower press pad 22 below the tool carrier 3 or 6 in order to make it possible to level surface irregularities in the building board 15.

FIG. 3 shows a building board 15 that is covered with an undercoat 14, a pattern 13 and an abrasion-resistant layer 12. A pattern-synchronous structure 11 has been embossed in the layer 12 by the device according to the invention for finishing building boards. A counteracting layer 16 is applied on the underside of the building board 15 to avoid warpage of the building board during changes in moisture.

FIG. 4 shows the finished building board 15 from FIG. 3 in plan view in which connecting mechanism tongues 17 and grooves 18 to connect several boards with one another have been formed on opposite lateral surfaces. To lock several building boards among one another in the horizontal and vertical direction locking elements (not shown) are formed on the connecting elements tongue 17 and groove 18.

1. A device for finishing a surface of a building board of a pressed wood material, by embossing a structure or printing a paftern with a pressing plate engraved with the structure or according to the pattern and a tool carrier supported in a press device, the tool carrier is a hollow body and the pressing plate is releasably attached to the tool carrier directly and over an entire surface of the building board.

2. The device according to claim 1, wherein the pressing plate thinner compared to the tool carrier.

3. The device according to claim 1, wherein a thickness of the pressing plate is 0.2 to 2 mm.

4. The device according to claim 3, wherein a thickness of the pressing plate is 0.5 mm.

5. The device according to claim 1, wherein the pressing plate is connected by adhesion to the tool carrier.

6. The device according to claim 1, wherein the pressing plate is attached to the tool carrier mechanically, pneumatically or magnetically.

7. The device according to claim 1, wherein the tool carrier is filled with a heat-transfer and/or pressure-transfer medium.

8. The device according to claim 1, wherein a wall thickness of the tool carrier on a side facing the pressing plate is approximately 1 mm.

9. The device according to claim 7, wherein the heat-transfer and pressure-transfer medium is thermal oil.

10. The device according to claim 7, wherein the tool carrier has a pressure tap for at least one of the heat-transfer and pressure-transfer medium.

11. The device according to claim 1, further comprising a press pad is arranged on a side of the tool carrier facing away from the pressing plate.

12. A method for engraving a structure into a pressing plate for use in the device according to claim 1, wherein the structure is made by a pulsed diamond tool.

13. The method according to the preamble of claim 12, wherein the structure is made by a laser.

14. The method according to the preamble of claim 12, wherein the structure is made die-sink eroding.

15. The method according to the preamble of claim 12, wherein the structure is made by etching.

16. The method according to claim 15, further comprising using laser etching, inkjet etching, screen printing or roll etching technologies.

17. The device according to claim 1, wherein the building board is made of one of a pressed wood material of MDF or HDF, and a wood material/plastic mixture.

18. A device, comprising:
two press cylinders;
an upper frame and a lower frame attached to the two press cylinder, respectively;
at least one tool carrier comprising a hollow body attached to the upper frame or to the lower frame; and
a pressing plate engraved with the structure or according to a pattern and attached to the at least one tool carrier.

19. The device according to claim 18, wherein the tool carrier is a hollow metal body.

20. The device according to claim 18, wherein the at least one tool carrier is two tool carriers and further comprising an upper press pad and a lower press pad positioned below each of the tool carriers structured to level surface irregularities in a building board.
